(19) United States
(12) Patent Application Publication
(10) Pub. No.: US 2019/0267145 A1
(43) Pub. Date: Aug. 29, 2019

(54) INCORE NEUTRON INSTRUMENTATION SYSTEM

(71) Applicant: Mitsubishi Electric Corporation, Chiyoda-ku, Tokyo (JP)

(72) Inventors: Atsushi Saito, Tokyo (JP); Toshihide Aiba, Tokyo (JP)

(73) Assignee: Mitsubishi Electric Corporation, Chiyoda-ku, Tokyo (JP)

(21) Appl. No.: 16/334,479

(22) PCT Filed: Nov. 22, 2016
(86) PCT No.: PCT/JP2016/084586

§ 371 Date: Mar. 19, 2019

(51) Int. Cl. G21C 17/108; G01T 3/00

(52) U.S. Cl. CPC G21C 17/108; G01T 3/00

(57) ABSTRACT

Non-contact sensors are used as a pull-out limit switch and a safety limit switch, so that contact between a drive cable and a thimble tube and both limit switches is avoided and abrasion of both limit switches is eliminated. In addition, erroneous detection due to vibration of the thimble tube is prevented by eliminating contact between the thimble tube and both limit switches, whereby accuracy of passing of a detector is enhanced.

### TECHNICAL FIELD

The present invention relates to switches for detecting the position of a neutron detector in a nuclear reactor incore neutron instrumentation system which measures a neutron flux in a nuclear power plant.

### BACKGROUND ART

Conventionally, in a nuclear reactor incore neutron instrumentation system (which measures a distribution of a neutron amount in a nuclear reactor periodically, normally, approximately once a month, and is hereinafter referred to as “incore neutron instrumentation system”), a pull-out limit switch that determines a stop position of a movable incore neutron flux detector (hereinafter referred to as “detector”) and a safety limit switch that is a backup for the pull-out limit switch are provided in order to avoid breakage of the detector due to excessive winding of the detector into a drive unit that drives the detector in order to acquire map data indicating a measurement result regarding a detected neutron amount.

Conventionally, contact type limit switches are used as these limit switches, and thus there are problems about maintainability such as deterioration of measurement accuracy due to abrasion. As a means for improving the maintainability of the pull-out limit switch and the safety limit switch in the incore neutron instrumentation system as described above, there is a proposal in which non-contact sensors using magnetism are used as the pull-out limit switch and the safety limit switch, thereby improving the maintainability of the pull-out limit switch and the safety limit switch (see, for example, Patent Document 1).

However, in this configuration, contact between a thimble tube through which the detector passes and a limit switch that is a sensor is inevitable. In addition, a drive cable has a structure in which a helical wire is wound on a core wire. Thus, a possibility cannot be denied that, when the detector passes through the thimble tube, the thimble tube vibrates, or erroneous detection that projections and recesses of the drive cable are detected, occurs.

### CITATION LIST

### Patent Document

Patent Document 1: Japanese Laid-Open Patent Publication No. 2005-195572

### SUMMARY OF THE INVENTION

### Problems to be Solved by the Invention

Since the conventional incore neutron instrumentation system is configured with the magnetic sensors as described above, there is a possibility that the thimble tube and the detector are erroneously detected. When such erroneous detection occurs, a possibility cannot be denied that the detector is excessively wound, that is, the detector is wound into the drive unit, so that the detector becomes entangled with a mechanism within the drive unit, resulting in breakage of the detector itself.

In addition, in order to simultaneously replace the safety limit switch and the pull-out limit switch as sensors mounted on the thimble tube through which the detector directly passes, an operator inevitably performs manual work in the vicinity of the detector having a relatively high radiation dose, or in the vicinity of the thimble tube activated due to passing of the detector, specifically, in a range where the thimble tube and the safety limit switch or the pull-out limit switch can be touched by a hand. Thus, there is a problem that the operator is at risk of radiation exposure. This situation will be described in more detail below with reference to a drawing.

Work for replacing the limit switches will be described with reference to FIG. 5.

FIG. 5 illustrates an example of an existing safety/pull-out/correction limit switch unit that has three purposes of safety, pull-out, and correction.

In the drawing, a limit switch 211 including a roller portion 202 having, at a lower portion thereof, a roller 201 that rolls is mounted at a center portion of a limit switch unit 200. In addition, a hollow tubular cavity 212 through which a drive cable passes is provided below the limit switch unit 200. Normally, the limit switch unit 200 is connected to a thimble tube by a joint at each of both end portions 213a and 213b of the cavity 212.

During each periodical inspection, an end position (lowest end position) of the roller 201 needs to be set to an appropriate position in a height direction (a Z direction in the drawing) such that, when the drive cable moves in the cavity 212 in an X direction shown in the drawing, the drive cable does not come into contact with a boundary surface, which is the tubular surface of the cavity 212, to cause vibration. Therefore, the set position is adjusted through manual work by the operator.

As described above, at the time of measurement of neutrons within the nuclear reactor, the drive cable passes through the interior (the cavity 212) of the limit switch unit for safety/pull-out/correction, and thus abrasion of the roller portion 202 is inevitable. This is because the hardness of the drive cable is high. Therefore, for example, due to the abrasion, the limit switches are conventionally replaced approximately once a year. In addition, for the roller portion, a run-on amount that is an adjustment amount for mounting the roller portion to a normal operating position needs to be adjusted, and the dimension of the roller portion 202 is actually adjusted every periodical inspection.

Meanwhile, abrasion powder that is generated due to the above abrasion is likely to accumulate in the cavity 212, through which the drive cable passes, and the detector having a relatively high radiation dose also passes through the cavity 212. Thus, the roller portion 202 is activated by radiation, and the operator is at risk of radiation exposure at the time of disassembly of the limit switch unit involved in the adjustment work or at the time of position adjustment.

The present invention has been made to solve the above-described problems, and an object of the present invention is to use a non-contact sensor, composed of a coil that generates a current as a result of change of conductor resistance, as each of a pull-out limit switch and safety limit switch, thereby allowing passing of a detector through a stop position to be detected on the basis of variation of the conductor resistance, and to provide a pull-out limit switch and a safety limit switch, which are completely isolated from the detector, thereby causing no abrasion of the limit switches and allowing the life of the limit switches to be extended, and also reducing a possibility that an operator is exposed to radiation by abrasion powder or the like at the time of inspection. Furthermore, another object of the present invention is to provide an incore neutron instrumentation system in which winding of a detector into a drive unit is prevented by improving a method for mounting limit switches and a method for controlling movement of the detector, resulting in no possibility that the detector itself is broken.

### Solution to the Problems

An incore neutron instrumentation system according to the present invention includes:

a detector measuring a neutron flux within a nuclear reactor;

a drive cable connected to the detector and moving the detector to a measurement position within the nuclear reactor;

a drive unit driving the drive cable for moving the detector;

a control panel for controlling the drive unit;

a pull-out limit switch disposed in a non-contact manner with the drive cable and outputting a signal for determining presence/absence of passing of the detector, for pulling out the detector from the measurement position within the nuclear reactor and stopping the detector at a predetermined stop position;

a safety limit switch disposed in a non-contact manner with the drive cable and outputting a signal for determining presence/absence of passing of the detector and turning off power of the drive unit, for turning off the power of the drive unit and stopping movement of the detector; and

a signal transmission unit transmitting output signals from the pull-out limit switch and the safety limit switch, to the control panel, wherein

the detector is moved from an inside of the nuclear reactor to an outside of the nuclear reactor or from the outside of the nuclear reactor to the inside of the nuclear reactor, and a neutron flux generated within the nuclear reactor is measured.

### Effect of the Invention

According to the present invention, in the incore neutron instrumentation system, contact between the pull-out limit switch and the safety limit switch, and the detector and the drive cable is completely eliminated, and the pull-out limit switch and the safety limit switch, which are sensors, are not worn by the drive cable, so that it is possible to considerably improve the maintainability of the pull-out limit switch and the safety limit switch, that is, adjustment and periodical replacement cycles for the pull-out limit switch and the safety limit switch. In addition, in replacement of the safety limit switch and the pull-out limit switch, abrasion powder due to passing of the detector is not generated, and thus risk of an operator being exposed to radiation when carrying out replacement work can be considerably reduced.

### BRIEF DESCRIPTION OF THE DRAWINGS

FIG. 1 illustrates an example of the entire configuration of an incore neutron instrumentation system according to Embodiment 1 of the present invention.

FIG. 2 is an enlarged view of a main part of the incore neutron instrumentation system according to Embodiment 1 of the present invention.

FIG. 3 illustrates an example of a limit switch unit of the incore neutron instrumentation system according to Embodiment 1 of the present invention, and a device involved in controlling the limit switch unit.

FIG. 4 illustrates an example of a limit switch unit of an incore neutron instrumentation system according to Embodiment 2 of the present invention, and a device involved in controlling the limit switch unit.

FIG. 5 is a perspective view showing an example of a conventional limit switch unit.

### DESCRIPTION OF EMBODIMENTS

### Embodiment 1

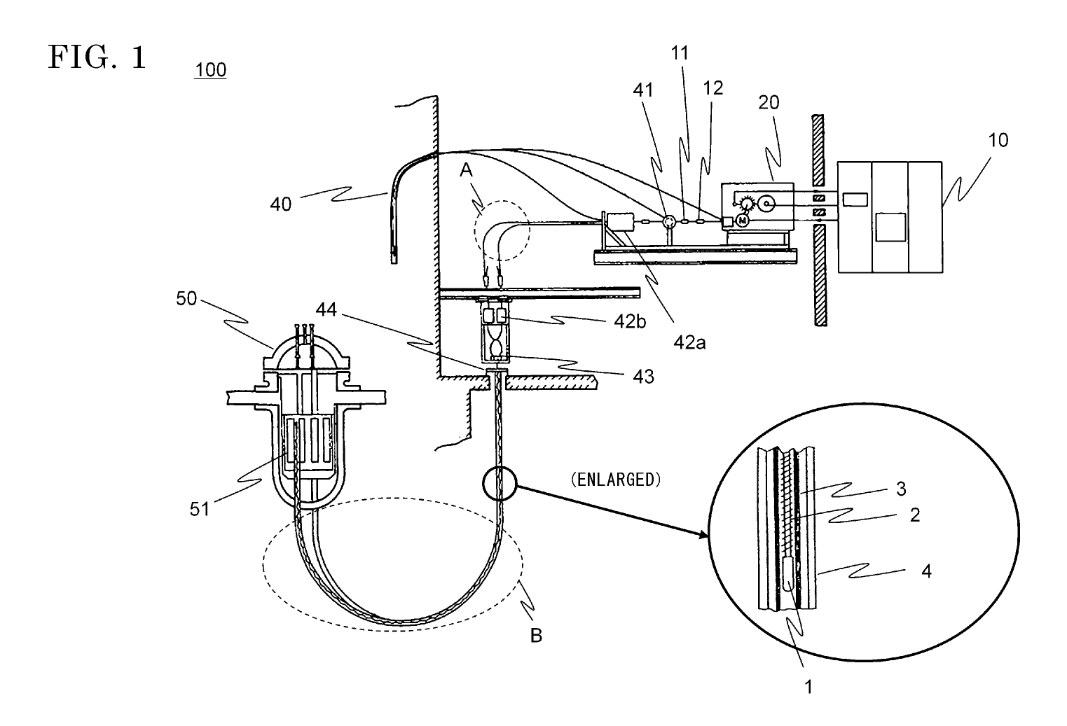

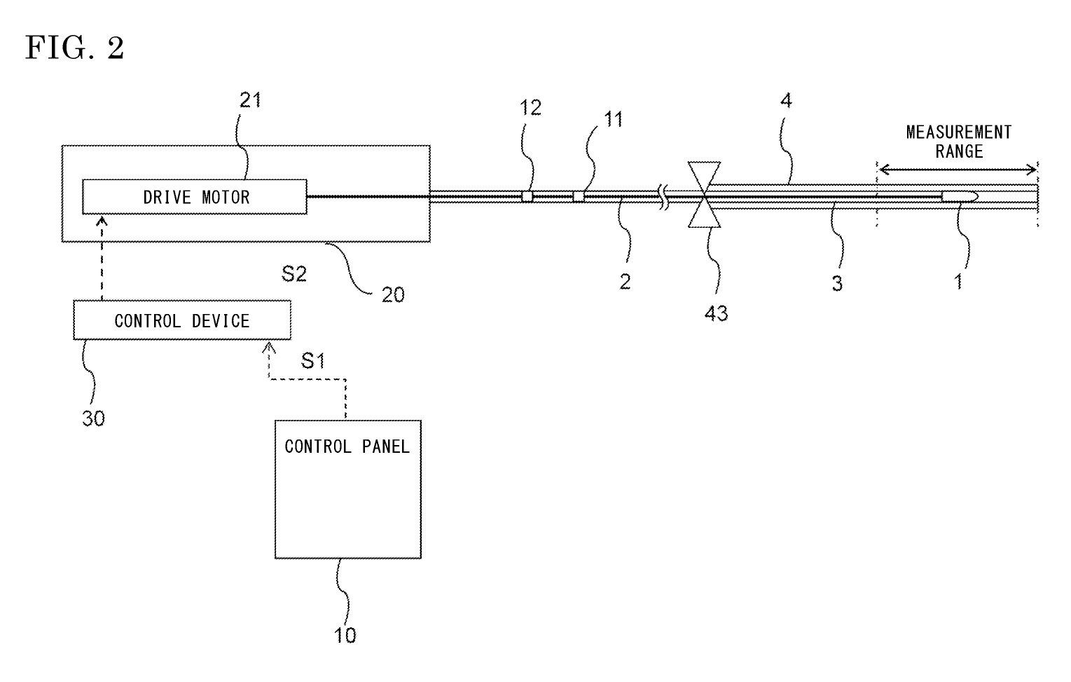

Hereinafter, an incore neutron instrumentation system according to Embodiment 1 of the present invention will be described with reference to the drawings. FIG. 1 is a diagram for describing an example of the entire configuration of the incore neutron instrumentation system according to the present embodiment. FIG. 2 is an enlarged view of a main part of the incore neutron instrumentation system according to the present embodiment, and is a partial detailed diagram of FIG. 1.

FIG. 1 illustrates the entire configuration of the incore neutron instrumentation system 100. As shown in FIG. 1, the incore neutron instrumentation system 100 includes, as main components thereof: detectors 1 that are basic components serving as sensors for detecting neutrons; a pull-out limit switch 11 that is a sensor for determining a driving range of each detector 1; a safety limit switch 12; a drive cable 2 that is connected for supporting each detector 1 and moves together with the detector 1 to a measurement location; a thimble tube 3 on which both limit switches are mounted at predetermined positions and that is a hollow passage in which each detector 1 and each drive cable 2 move; an isolation valve 43 that separates the inside and the outside of a body of a nuclear reactor 50 from each other; a thimble guide tube 4 that protects, at the nuclear reactor 50 body side, the detector 1, which is disposed in the inside of the nuclear reactor body isolated from the pull-out limit switch 11 and the safety limit switch 12 by the isolation valve 43 and moves into a reactor core 51, and the thimble tube 3, which is a guide passage (normally, a plurality of guide passages are present) for the drive cable 2; a drive unit 20 for driving each detector 1; a switching unit 41 for, in the case where abnormality occurs in the detector 1 at the time of periodical inspection or during plant operation, driving the detector 1 by a synchronous motor (motor) mounted within the drive unit 20 and replacing a detector for periodical inspection, or switching the detector in which abnormality has occurred to a normal detector; a control panel 10 that controls driving operation of the drive unit 20; and a passage selection device 42 (42a, 42b) for selecting from which guide passage of the plurality of guide passages within the nuclear reactor the detector 1 is to be pulled out, and into which guide passage another detector 1 is to be inserted.

An auxiliary detector for neutron detection is provided in a storage pipe 40, and is made ready to be switched and used at any time when needed. In addition, a seal table 44 is mounted at the boundary between the inside and the outside of the nuclear reactor body. Furthermore, portions surrounded by broken lines and indicated by characters A and B are portions, that are not linear but curved, of the passages through which the detectors 1 move.

Next, FIG. 2 will be described. FIG. 2 is an enlarged view of a main part of the incore neutron instrumentation system according to Embodiment 1 of the present invention, and is a diagram showing a part of FIG. 1 in detail. Each component of the incore neutron instrumentation system 100 will be described in further detail with reference to this drawing.

As shown in FIG. 2, in the incore neutron instrumentation system 100, the pull-out limit switch 11, which serves as a sensor for determining a driving range of each detector 1 and is disposed at a predetermined position in a space, where the drive cable 2 moves, between the isolation valve 43 and the later-described drive unit 20, and the safety limit switch 12, which serves as a backup for the pull-out limit switch 11 and is used for stopping drive of the detector 1, are mounted.

In this case, the measurement range of the detector 1 is located at the nuclear reactor body side with respect to the isolation valve 43 as shown in the drawing. In addition, regarding a drive motor 21, a signal S1 outputted from the control panel on the basis of output currents transmitted from the pull-out limit switch 11 and the safety limit switch 12 to the control panel is inputted to a control device 30 that controls the drive motor 21, and is outputted as a control signal S2 to the drive motor 21.

The pull-out limit switch 11 is mounted near an outlet of the drive unit 20, and the safety limit switch 12 is mounted farther from the nuclear reactor body than the pull-out limit switch 11, that is, at a position closer to the drive unit 20. The thimble tube 3 is mounted over the entire detector passage, including the neutron measurement range, from the inside of a nuclear reactor containment vessel to a position of connection to the drive unit, without distinction between the inside and the outside of the nuclear reactor body, that is, the nuclear reactor containment vessel.

Next, operation of the limit switch will be described.

When the safety limit switch is turned OFF by a driving signal for driving the detector, the control device 30 forcedly cuts off power of the drive unit 20 to stop drive of the detector. That is, in order to prevent “excessive winding” by the drive motor (motor), the control device 30 locks the detector driving signal by the safety limit switch.

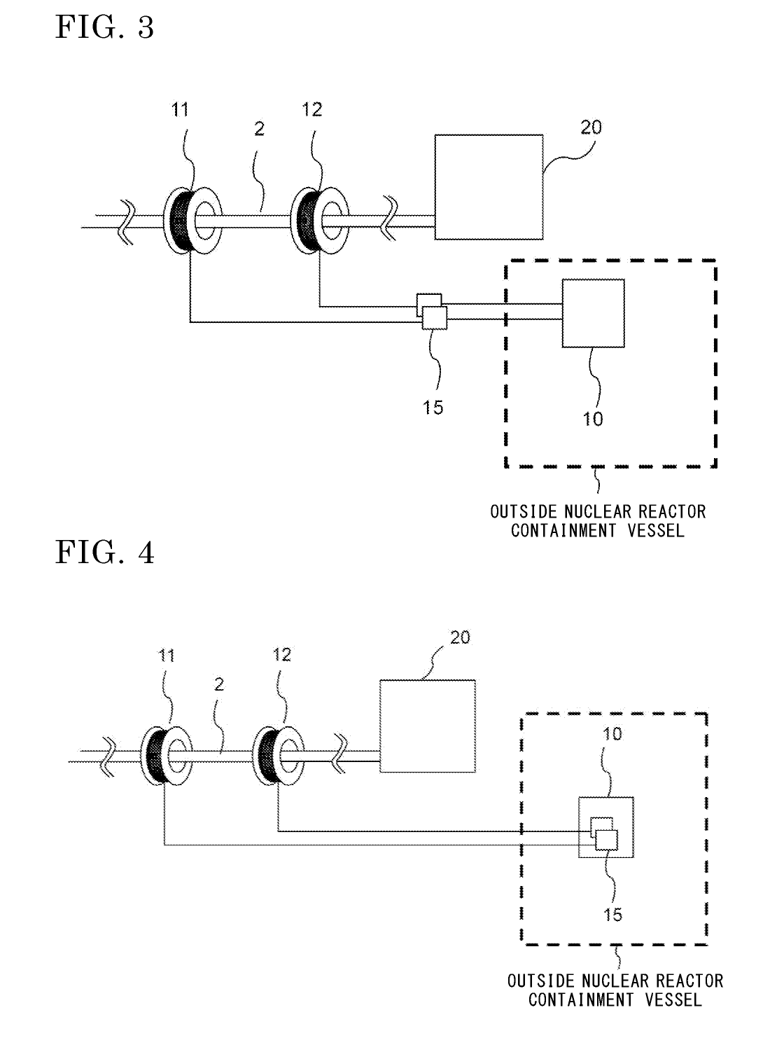

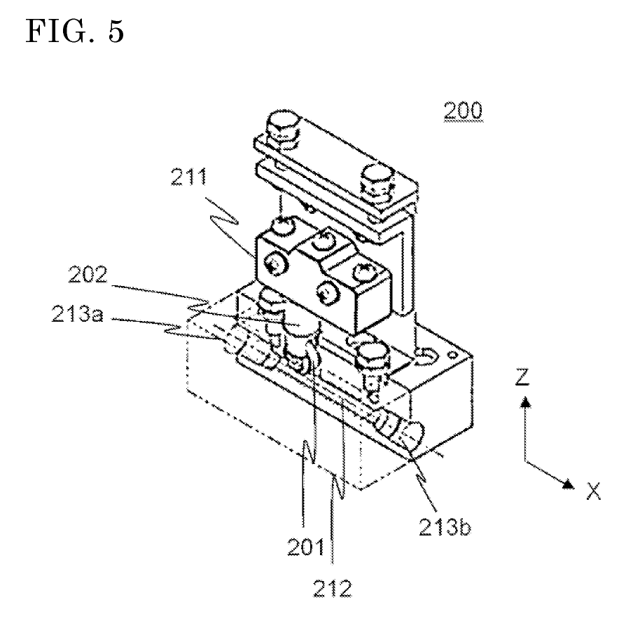

Next, operation of the incore neutron instrumentation system according to Embodiment 1 will be described with reference to FIG. 3.

FIG. 3 is a diagram for describing in detail the configuration of a portion around the safety limit switch 12 and the pull-out limit switch 11. As shown in this drawing, the control panel 10 is normally mounted outside the nuclear reactor containment vessel.

In this drawing, at the time of periodical inspection, the detector 1 is normally inserted into a passage in the nuclear reactor body or pulled out from this passage by the drive motor 21 in the drive unit. At this time, the detector passes, at a speed of approximately 36 m/min, through the positions at which the safety limit switch 12 and the pull-out limit switch 11 are mounted. The passage through which the detector 1 passes is linear at not all locations and includes curved portions as shown at the locations surrounded by broken lines and indicated by characters A and B in FIG. 1. Thus, during movement of the drive cable 2, the drive cable 2 comes into contact with the thimble tube at the curved portions and decelerates, and thus the driving speed of the detector 1 is normally not constant. In addition, vibration is caused by projections and recesses of the drive cable and contact with the thimble tube 3. Thus, in the case where a conventional type of sensor is used, erroneous detection or deterioration of detection accuracy is caused by the above-described projections and recesses of the drive cable or the caused vibration of the thimble tube 3 in some cases.

On the other hand, the safety limit switch 12 and the pull-out limit switch 11 shown in this drawing are completely in non-contact with the detector 1 and the thimble tube 3, and the incore neutron instrumentation system according to the present embodiment employs a method in which whether the detector has passed through the inside of a coil is detected on the basis of variation of the conductor resistance of the coil that is caused due to presence/absence of a magnetic body within the coil.

Therefore, erroneous detection, which is conventionally caused by the projections and recesses of the drive cable or vibration of the thimble tube 3 due to the above vibration, can be prevented, and it is possible to achieve high detection accuracy.

Regarding the conductor resistance of coil portions of the safety limit switch and the pull-out limit switch, power is supplied from signal transmission units 15 and changes thereof are detected.

Next, the detection method of each non-contact type limit switch will be described.

The detection method is as follows. Each limit switch includes a coil portion having a coil for detecting conductor resistance, and the coil portion outputs an AC signal corresponding to presence/absence of the detector and the drive cable within the coil portion. When the detector and the drive cable are inserted into the coil portion, the inductance of the coil that forms the coil portion increases, and the signal transmission unit transmits a phase shift of the detected output signal to the control panel, whereby it is possible to recognize presence/absence of passing of the detector.

As described above, in the incore neutron instrumentation system according to Embodiment 1, since the two kinds of non-contact type limit switches (the pull-out limit switch and the safety limit switch) are used, these two kinds of limit switches are not worn by the drive cable, so that it is possible to considerably improve the maintainability of the pull-out limit switch and the safety limit switch, that is, adjustment and periodical replacement cycles for the pull-out limit switch and the safety limit switch. In addition, since the non-contact type limit switches are used, in replacement of the safety limit switch and the pull-out limit switch, abrasion powder from the limit switches due to passing of the detector is not generated, and thus risk of an operator being exposed to radiation when carrying out replacement work can be considerably reduced as compared to that in the conventional art.

### Embodiment 2

Next, an incore neutron instrumentation system according to Embodiment 2 will be described with reference to FIG. 4.

FIG. 4 is a diagram for describing an example of the case with a different configuration of the portion around the safety limit switch 12 and the pull-out limit switch 11 from that in Embodiment 1.

As shown in this drawing, the signal transmission units 15 are mounted within the control panel 10 that is mounted outside the nuclear reactor containment vessel such as in a control center, and this point is the difference from Embodiment 1. With such a configuration, even when a problem occurs in the signal transmission unit 15, the signal transmission unit 15 can be easily repaired as compared to the case where the signal transmission units 15 are mounted within the nuclear reactor containment vessel.

Next, operation of the incore neutron instrumentation system according to Embodiment 2 will be described. In FIG. 4, operation of driving the detector is the same as described in Embodiment 1, and thus the detailed description thereof is omitted. In addition, since the signal transmission units 15 are mounted outside the nuclear reactor containment vessel which is a radiation environment, it is not necessary to take into consideration durability against the environment specific to the nuclear reactor containment vessel such as radiation, temperature, and humidity, and it is also unnecessary to register work to be performed under a radiation environment, and to qualify the operator. Thus, inspection and adjustment become easy. In addition, influence of radiation on an electronic circuit or a power supply device can be ignored, and thus an effect that the replacement cycle related to maintainability can be extended as compared to that in Embodiment 1, is also achieved.

The function of each signal transmission unit is to supply power to the coil portion and to monitor change of an output current. Thus, in Embodiment 2, other than the above description, by mounting the signal transmission units in the control device, it is possible to inspect the signal transmission units simultaneously with the control device, so that the maintainability can be also improved.

It is noted that, within the scope of the present invention, the above embodiments may be freely combined with each other, or each of the above embodiments may be modified or simplified as appropriate.

### DESCRIPTION OF THE REFERENCE CHARACTERS

1 detector
2 drive cable
3 thimble tube
4 thimble guide tube
10 control panel
11 pull-out limit switch
12 safety limit switch
15 signal transmission unit
20 drive unit
21 drive motor
30 control device
43 isolation valve
100 incore neutron instrumentation system

1.-5. (canceled)

6. An incore neutron instrumentation system comprising:
a detector measuring a neutron flux within a nuclear reactor;
a drive cable connected to the detector and moving the detector to a measurement position within the nuclear reactor;
a thimble tube which is a hollow passage in which the detector and the drive cable move;
a drive unit driving the drive cable for moving the detector;
a control panel for controlling the drive unit;
a pull-out limit switch disposed in non-contact with the drive cable and the thimble tube and outputting a signal for determining presence/absence of passing of the detector, for pulling out the detector from the measurement position within the nuclear reactor and stopping the detector at a predetermined stop position;
a safety limit switch disposed in non-contact with the drive cable and the thimble tube and outputting a signal for determining presence/absence of passing of the detector and turning off power of the drive unit, for turning off the power of the drive unit and stopping movement of the detector; and
a signal transmission unit transmitting output signals from the pull-out limit switch and the safety limit switch, to the control panel, wherein
the detector is moved from an inside of the nuclear reactor to an outside of the nuclear reactor or from the outside of the nuclear reactor to the inside of the nuclear reactor, and a neutron flux generated within the nuclear reactor is measured.

7. The incore neutron instrumentation system according to claim 6, wherein the pull-out limit switch and the safety limit switch each include a coil portion having a coil for generating a current as a result of change of conductor resistance.

8. The incore neutron instrumentation system according to claim 6, wherein the safety limit switch is provided at a side closer to the drive unit than the pull-out limit switch, and drive of the drive cable is stopped on the basis of the output signal from the safety limit switch.

9. The incore neutron instrumentation system according to claim 7, wherein the safety limit switch is provided at a side closer to the drive unit than the pull-out limit switch, and drive of the drive cable is stopped on the basis of the output signal from the safety limit switch.

10. The incore neutron instrumentation system according to claim 6, wherein the signal transmission unit is mounted within a nuclear reactor containment vessel and connected to the pull-out limit switch, the safety limit switch, and the control panel.

11. The incore neutron instrumentation system according to claim 7, wherein the signal transmission unit is mounted within a nuclear reactor containment vessel and connected to the pull-out limit switch, the safety limit switch, and the control panel.

12. The incore neutron instrumentation system according to claim 6, wherein the signal transmission unit is mounted within the control panel disposed outside a nuclear reactor containment vessel, and is connected to the pull-out limit switch and the safety limit switch.

13. The incore neutron instrumentation system according to claim 7, wherein the signal transmission unit is mounted within the control panel disposed outside a nuclear reactor containment vessel, and is connected to the pull-out limit switch and the safety limit switch.
